(19) United States
(12) Patent Application Publication
(10) Pub. No.: US 2016/0102197 A1
(43) Pub. Date: Apr. 14, 2016

(54) TRANSPARENT, IMPACT-MODIFIED STYRENE-COPOLYMER-BASED MOLDING COMPOUND

(71) Applicant: STYROLUTION GROUP GMBH, Frankfurt (DE)

(72) Inventors: Philipp BOECKMANN, Bad Duerkheim (DE); Sven FLEISCHMANN, Ludwigshafen (DE); Matthias MUELLER, Pfungstadt (DE); Pascal HESSE, Mannheim (DE); Jordan KOPPING, Weinheim (DE)

(21) Appl. No.: 14/890,680

(22) PCT Filed: May 12, 2014
(86) PCT No.: PCT/EP2014/059634

§ 371 Date: Nov. 12, 2015

(30) Foreign Application Priority Data
May 14, 2013 (EP) 13167652.0

(51) Int. Cl. C08L 25/12

(52) U.S. Cl. CPC C08L 25/12

(57) ABSTRACT

The invention relates to thermoplastic molding compounds which contain impact-modified styrene/nitrile monomer copolymers, to molded products and films produced therefrom and to the use thereof. The impact modifiers used are linear A-B-A tri-block copolymers from hard polymer blocks A and a soft polymer block B, preferably polymethylmethacrylate-block-polybutylacrylate-block-polymethylmethacrylate.

The invention relates to thermoplastic molding compositions comprising impact-modified styrene/nitrile monomer copolymers, moldings and films produced therefrom, and also use thereof.

Molding compositions made of styrene-acrylonitrile copolymers (SAN) are transparent and rigid, and are widely used in the household sector and sanitary sector, in packaging of cosmetic products, and also for electronic and office products. SAN copolymers feature on the one hand high rigidity, dimensional stability, and temperature resistance, and on the other hand high transparency and resistance to chemical reagents.

The unsatisfactory tensile strain at break of SAN copolymers is disadvantageous. Even small tensile strain values result in fracture in tensile strain tests.

Improvement is therefore required to the mechanical properties of SAN copolymers in respect of tensile strain at break and also of impact resistance.

It is known that the impact resistance of SAN copolymers can be increased via addition of fine-particle, or fine- and coarse-particle, graft copolymers (core-shell particles) based on acrylate rubbers or on butadiene rubbers (e.g. DE-A-12 60 135, DEA-23 11 129 and DE-A-28 26 925). It is however disadvantageous that addition of said core-shell particles reduces the transparency of the SAN copolymer and gives opaque materials with significantly reduced weathering resistance.

WO2008/063988 A2 discloses that diblock and triblock copolymers are efficient impact modifiers for biodegradable polymers, in particular polylactic acid. Polymethyl methacrylate-polybutyl acrylate-polymethyl methacrylate (PMMA-PBA-PMMA) triblock copolymers (Nanostrength® (®=registered trademark of Arkema) are used commercially as compatibilizers for epoxy resins.

WO 2007/140192 A2 describes acid-functionalized gradient triblock copolymers based on P(MMA)-b-P(BA)-b-P(MMA). The triblock copolymers thus modified can be used in many ways, inter alia as impact modifiers for polymers. There are no relevant usage examples.

WO 2013/030261 describes a process for the production of block copolymers via controlled free-radical polymerization with the aid of Cu(0)-containing catalysts and initiators based on organic halides. Triblock copolymers made of pMMA-b-pBA-b-pMMA are preferably produced. Triblock copolymers of this type can be used inter alia as impact modifiers for styrene-acrylonitrile copolymers. There are no examples of mixtures of this type.

The invention provides a thermoplastic molding composition comprising, or composed of, the following components:
K1: from 60 to 90% by weight of at least one copolymer K1 made of:
   K11: from 70 to 85% by weight of at least one styrene or styrene derivative K11,
   K12: from 30 to 15% by weight of at least one ethylenically unsaturated monomer K12 comprising a nitrile group,
   K13: from 0 to 20% by weight of at least one other, copolymerizable monomer K13, where the entirety of K11, K12, and K13 gives 100% by weight;
K2: from 40 to 10% by weight of at least one linear A-B-A triblock copolymer K2 made of:
   A: from 50 to 70 mol % of hard polymer blocks A comprising at least one C₁- to C₄-alkyl methacrylate (A1); and
   B: from 30 to 50 mol % of a soft polymer block B composed of at least one C₁- to C₁₂-alkyl acrylate B1;
K3: from 0 to 10% by weight of auxiliaries and/or additives K3; and
K4: from 0 to 15% by weight of at least one copolymer K4 made of styrene and of another ethylenically unsaturated comonomer which comprises no nitrile group; where the entirety of components K1 to K4 gives 100% by weight.

It is preferable that the thermoplastic molding compositions of the invention are composed of from 65 to 90% by weight of component K1, from 35 to 10% by weight of component K2, from 0 to 10% by weight of component K3, and from 0 to 15% by weight of component K4.

It is particularly preferable that the thermoplastic molding compositions of the invention are composed of from 70 to 90% by weight of component K1, from 30 to 10% by weight of component K2, from 0 to 10% by weight of component K3, and from 0 to 15% by weight of component K4.

Very particular preference is given to thermoplastic molding compositions of the invention composed of components K1 and K2, and also optionally K3.

Quantities used of component K1 are from 60 to 90% by weight, preferably from 65 to 90% by weight, in particular from 70 to 90% by weight, very particularly preferably from 71 to 86% by weight. It is preferable that K1 is an SAN copolymer with molar mass from 50 000 to 150 000 g/mol. The AN content of these materials is often from 18 to 28% by weight.

Suitable monomers K11 are styrene and styrene derivatives such as α-methylstyrene and ring-alkylated styrenes such as p-methylstyrene and/or tert-butylstyrene. It is preferable to use styrene, α-methylstyrene, and/or p-methylstyrene, in particular styrene and/or α-methylstyrene, and it is very particularly preferable to use styrene.

Monomers K12 used are preferably acrylonitrile and/or methacrylonitrile. Particular preference is given to acrylonitrile.

The proportion of the monomer K11 in the copolymer K1 is generally from 70 to 85% by weight, particularly preferably from 70 to 83% by weight, very particularly preferably from 73 to 83% by weight.

The proportion of the monomer K12 in the copolymer K1 is generally from 30 to 15% by weight, particularly preferably from 30 to 17% by weight, very particularly preferably from 27 to 17% by weight.

The copolymer K1 can moreover also comprise from 0 to 20% by weight, preferably from 0 to 10% by weight, of at least one other copolymerizable monomer K13, for example methyl acrylate, ethyl acrylate, propyl acrylate, methyl methacrylate, ethyl methacrylate, phenylmaleimide, maleic anhydride, acrylamide, and/or vinyl methyl ether.

It is preferable that the copolymer K1 is composed only of units of the monomers K11 and K12.

Preferred copolymers K1 are copolymers of styrene and acrylonitrile and/or copolymers of α-methylstyrene and acrylonitrile. It is particularly preferable that K1 is a copolymer of styrene and acrylonitrile.

Preference is given to a copolymer of from 70 to 85% by weight of styrene and from 30 to 15% by weight of acrylonitrile, particularly of from 70 to 83% by weight of styrene and from 30 to 17% by weight of acrylonitrile, very particularly of from 73 to 83% by weight of styrene and from 27 to 17% by weight of acrylonitrile.

The number-average molar mass (Mₙ) of the copolymer K1 is generally from 30 000 to 150 000 g/mol, preferably from 50 000 to 120 000 g/mol. The viscosity (Vz) of the copolymer K1 is by way of example from 50 to 120 ml/g (measured in accordance with DIN 53726 at 25° C. in 0.5% by weight solution in DMF). The copolymer K1 can be produced via bulk polymerization or solution polymerization in, for example, toluene or ethylbenzene by a process as described by way of example in Kunststoff-Handbuch [Plastics Handbook], Vieweg-Daumiller, volume V, (Polystyrol [Polystyrene]), Carl-Hanser-Verlag, Munich, 1969, pp. 122 ff., lines 12 ff.

Component K2 functions as impact modifier, and quantities used thereof are generally from 40 to 10% by weight, preferably from 35 to 10% by weight, particularly preferably from 30 to 10% by weight, very particularly preferably from 29 to 14% by weight.

The triblock copolymer K2 is generally a linear hard-soft-hard-(A-B-A)-segment triblock copolymer made of two hard terminal polymer blocks A and of a soft polymer block B arranged between the blocks A.

The molecular weights Mₙ of the triblock copolymer K2 are generally in the range from 15 000 to 300 000, preferably in the range from 50 000 to 150 000.

The proportion of the polymer block B in the triblock copolymer K2 is generally from 30 to 50 mol %, preferably from 35 to 50 mol %. The proportion of the polymer blocks A in the triblock copolymer K2 is from 50 to 70 mol %, preferably from 50 to 65 mol %, where the sum of the proportions A and B is 100 mol %.

The soft polymer block B is generally composed of monomer units of one or more alkyl acrylates (B1) having a straight-chain or branched alkyl moiety having from 1 to 12 carbon atoms, preferably from 2 to 8 carbon atoms, particularly preferably from 4 to 8 carbon atoms, in particular n-butyl acrylate and/or ethylhexyl acrylate. Particular preference is given to n-butyl acrylate.

The hard polymer blocks A generally comprise, or are composed of, one or more C₁- to C₄-alkyl methacrylates (A1), preferably methyl methacrylate and/or ethyl methacrylate, particularly preferably methyl methacrylate. The abovementioned monomers (A1) can optionally also be used in a mixture with one or more monomers (A1′). Suitable monomers (A1′) are methacrylic ester derivatives, preferably epoxy-, hydroxy-, or carboxy-functionalized alkyl methacrylates, particularly preferably epoxy-functionalized alkyl methacrylates (A1′) such as glycidyl methacrylate.

It is very particularly preferable to use glycidyl methacrylate as monomer (A1′). Glycidyl methacrylate is a commercially available product and can be purchased by way of example from Aldrich. The proportion of the comonomer (A1′), based on the entire monomer content of (A1)+(A1′), can be from 2 to 10 mol %, preferably from 4 to 8 mol %.

The B:A molar ratio of the polymer blocks is generally 1.0:2.5, preferably 1.0:1.5, particularly preferably 1.0:1.0.

Very particular preference is given to triblock copolymers K2 of the polymethyl methacrylate-block-polybutyl acrylate-block-polymethyl methacrylate (PMMA-b-PBA-b-PMMA) type.

Preference is further given to triblock copolymers K2 of the methyl methacrylate/glycidyl methacrylate-copolymer-block-polybutyl acrylate-block-methyl methacrylate/glycidyl methacrylate-copolymer (PMMA-co-PGMA-block-PBA-block-PMMA-co-PGMA) type.

Any technique for living or controlled polymerization can be used to produce the abovementioned triblock copolymers. It has proven advantageous to carry out the polymerization as two-stage one-pot synthesis in which the monomers B1 are first polymerized with a bifunctional initiator preferably involving organic chlorides or bromides (for example 2,6-dibromodiethylheptanedionate, ethyl 2,5-dibromoadipate) to produce the soft central block B, and once conversion has reached from 95 to 100% the two hard external blocks A are produced via addition and polymerization of the monomers A1 and optionally A1′.

Preference is given to production via controlled free-radical polymerization (CRP), in particular via an SET-LRP polymerization process (single electron transfer living radical polymerization). By way of example, the SET-LRP polymerization process described in WO 2008/019100 A2 with use of Cu(0), Cu₂Te, CuSe, Cu₂S, and/or Cu₂O catalysts is suitable.

Preference is given to the SET-LRP polymerization process described in WO 2013/030261 (p. 3, line 18 to p. 12, line 2), said process being expressly incorporated herein by way of reference. This uses, as catalyst, Cu in the form of Cu (0), Cu(I), Cu(II), or a mixture of these. Preference is given here to use of Cu(0) in the form of solid, in particular in the form of a wire, grid, net, or powder.

Before addition of the monomers A1 here it is preferable to add small quantities of a halide salt.

Conventional methods can be used for isolation and drying of the resultant triblock copolymer.

The thermoplastic molding compositions of the invention can optionally comprise one or more copolymers K4. The copolymers K4 are copolymers of styrene (K4-1) and another ethylenically unsaturated comonomer which comprises no nitrile group (K4-2). It is preferable that the copolymer K4 is a copolymer of styrene and methyl methacrylate.

Quantities used of the copolymer K4 can be from 0 to 15% by weight, preferably from 5 to 10% by weight.

Preference is given to thermoplastic molding compositions of the invention composed of components K1 and K2 and optionally K3.

The thermoplastic molding composition can optionally comprise from 0 to 10% by weight of auxiliaries and/or additives as further component K3.

The thermoplastic molding compositions of the invention can comprise, as component K3, from 0 to 5% by weight of fibrous or particulate fillers or a mixture thereof, based in each case on the total quantity of components K1 to K4. Examples of fillers or reinforcing materials that can be added are glass fibers, which can have been equipped with a size and with a coupling agent, glass beads, mineral fibers, and aluminum oxide fibers.

Examples that may be mentioned of preferred fibrous or pulverulent fillers are carbon fibers or glass fibers in the form of woven glass fabrics, glass matts, or glass silk rovings, chopped glass, and also glass beads, particularly glass fibers. When glass fibers are used, these can have been equipped with a size and with a coupling agent in order to improve compatibility with the blend components.

When the glass fibers are incorporated they can take the form of short glass fibers or else of continuous-filament strands (rovings).

Other substances that can be used as auxiliaries and/or additives (K3) are any of those usually used for the processing or modification of polymers.

Examples that may be mentioned are colorants, antistatic agents, antioxidants, stabilizers for improving thermal stability, stabilizers for improving light resistance, stabilizers for increasing hydrolysis resistance and chemicals resistance, agents to thermal decomposition, and in particular lubricants, where these are advantageous for the production of moldings.

These further additives can be metered into the material at any stage of production process, but preferably at an early juncture, in order to permit early utilization of the stabilizing effects (or other specific effects) of the additive. In respect of other conventional auxiliaries and additives reference is made by way of example to “Plastics Additives Handbook”, eds. Gächter and Müller, 4th edition, Hanser Publ., Munich, 1996.

Examples of suitable colorants are any of the dyes that can be used for the transparent, semitransparent, or nontransparent coloring of polymers, in particular those suitable for the coloring of styrene copolymers.

Suitable flame retardants that can be used are by way of example the halogen- or phosphorus-containing compounds known to the person skilled in the art, magnesium hydroxide, and also other familiar compounds, and mixtures thereof.

Examples of suitable antioxidants are sterically hindered mononuclear or polynuclear phenolic antioxidants which can have various substitution patterns and also can have bridging by way of substituents. Among these are not only monomeric but also oligomeric compounds which can be composed of a plurality of phenolic parent structures. Other compounds that can be used are hydroquinones and hydroquinone-analogous substituted compounds, and also antioxidants based on tocopherols, and on derivatives thereof. It is also possible to use mixtures of various antioxidants. In principle it is possible to use any of the compounds that are commercially available or are suitable for styrene copolymers, e.g. antioxidants from the Irganox product line.

It is possible to use what are known as costabilizers, in particular phosphorus- or sulfo-containing costabilizers, together with the phenolic antioxidants mentioned by way of example above. These P- or S-costabilizers are known to the person skilled in the art.

Suitable stabilizers to counter the action of light are by way of example various substituted resorcinols, salicylates, benzotriazoles, and benzophenones. Matting agents used can be either inorganic substances such as talc powder, glass beads, or metal carbonates (e.g. MgCO₃, CaCO₃) or else polymer particles—in particular spherical particles with d₅₀ diameters above 1 mm—based by way of example on methyl methacrylate, styrene compounds, acrylonitrile, or a mixture thereof. It is moreover also possible to use polymers which comprise acidic and/or basic monomers incorporated into the polymer.

Examples of suitable anti-drip agents are polytetrafluoroethylene (Teflon) polymers and ultrahigh-molecular-weight polystyrene (molecular weight M_{w} above 2 000 000).

Examples of suitable antistatic agents are amine derivatives such as N,N-bis(hydroxyalkyl)alkylamines or -alkyleneamines, polyethylene glycol esters, copolymers of ethylene oxide glycol and propylene oxide glycol (in particular two-block or three-block copolymers made of ethylene oxide blocks and of propylene oxide blocks), and glycerol mono- and distearates, and also mixtures thereof.

Suitable stabilizers are by way of example sterically hindered phenols, and also vitamin E and compounds of structure analogous thereto, and also butylated condensates of p-cresol and dicyclopentadiene. Other suitable compounds are HALS stabilizers (hindered amine light stabilizers), benzophenones, resorcinols, salicylates, benzotriazoles. Examples of other suitable compounds are thiocarboxylic esters. It is also possible to use C₆-C₂₀-alkyl esters of thiopropionic acid, particularly the stearyl esters and lauryl esters. It is also possible to use dilauryl thiodipropionate, distearyl thiodipropionate or a mixture thereof. Examples of other additives are HALS absorbers such as bis(2,2,6,6-tetramethyl-4-piperidyl) sebacate, or UV absorbers such as 2H-benzotriazol-2-yl-(4-methylphenol). Quantities used of additives of these types are usually from 0.01 up to 2% by weight (based on the entire mixture).

Suitable lubricants and mold-release agents are stearic acids, stearyl alcohol, stearic esters, amide waxes (bisstearylamide), polyolefin waxes, and in general terms higher fatty acids, derivatives thereof, and corresponding fatty acid mixtures having from 12 to 30 carbon atoms. Ethylenebisstearamide is also particularly suitable (an example being Irgawax, produced by Ciba, Switzerland). Quantities of these additions are in the range from 0.05 to 5% by weight.

Silicone oils, oligomeric isobutylene and other substances can be used as additives. The conventional quantities, if used, are from 0.001 to 3% by weight, based on the quantity of components K1 to K4. It is also possible to use pigments, dyes, color brighteners such as ultramarine blue, phthalocyanines, titanium dioxide, cadmium sulfides, and derivatives of perylenetetracarboxylic acid. Usual quantities used of processing aids and stabilizers such as UV stabilizers, heat stabilizers (e.g. butylated reaction products of p-cresol and dicyclopentadiene; Wingstay L; produced by: Omnova; and also dilauryl thiodipropionate, Irganox PS 800, produced by: BASF), lubricants, and antistatic agents (e.g. ethylene oxide-propylene oxide copolymers such as Pluronic, produced by: BASF), if used, are from 0.01 to 5% by weight, based on the entire quantity of components K1 to K4.

The quantities used of the individual additives are generally in each case those that are conventional.

Conventional known methods can be used to produce the molding compositions of the invention from components K1 and K2 (and optionally K4 and K3). However, it is preferable that the components are blended via mixing in the melt, for example by extruding, kneading, or rolling the components together. This is carried out at temperatures in the range from 160 to 400° C., preferably from 180 to 280° C.

When the thermoplastic molding compositions of the invention are compared with pure SAN copolymers they have markedly improved tensile strain at break and impact resistance. The thermoplastic molding composition of the invention moreover has good transparency and UV resistance.

The invention further provides moldings and films produced from the thermoplastic molding composition of the invention. Processing can be carried out by means of the known thermoplastics processing methods, and in particular production can be achieved via thermoforming, extrusion, injection molding, calendering, blow molding, compression molding, pressure sintering or other types of sintering, or thermoforming, preferably via injection molding.

The invention likewise provides the use of said films and moldings for external applications, for example in the automobile sector, and for the production of packaging material, or for the production of devices for medical technology or for medical diagnostics, and also in the toy sector and household sector.

The invention is explained in more detail by the examples below and by the claims:

The test methods used to characterize the polymers are first briefly summarized:
a) Molecular weight (Mₙ)
   Number-average molecular weight Mₙ is determined by means of GPC with UV detection.
b) Molecular weight (M_{w})
   Weight-average molecular weight M_{w} is determined by means of GPC with UV detection.
c) Viscosity (Vz)
   Viscosity is measured in accordance with DIN 53726 at 25° C. in 0.5% by weight solution in DMF.
d) Modulus of elasticity (MPa)
   Modulus of elasticity is determined in accordance with ISO 527-2:1993.
e) Yield stress (MPa)
   Yield stress is determined in accordance with DIN ISO 527 at 23° C.
f) Charpy notched impact resistance [kJ/mm²]:
   Notched impact resistance is determined on test specimens (80×10×4 mm) produced via injection molding at melt temperature 240° C. and mold temperature 70° C. at 23° C. in accordance with ISO 179-1A.
g) Flowability (MVR [ml/10 min]):
   Flowability is determined on a polymer melt at 220° C. with 10 kg load in accordance with ISO 1133.
h) Vicat softening point A₅₀ (° C.)
   Vicat softening point is determined in accordance with DIN ISO 306.
i) Tensile strain at break (%)
   Tensile strain at break is determined in accordance with DIN ISO 527 at 23° C.
j) Transmittance (%)
   Transmittance is measured in accordance with DIN 53236.
k) Haze
   Haze is determined in accordance with ASTM D1003 on specimens of thickness 2 mm.

### EXAMPLES

### Synthesis of the Triblock Copolymers K2

### Triblock Copolymer K2-3

The reactor was equipped with a blade stirrer around which a copper wire of length 0.5 m had been wound. The following were supplied in succession to the apparatus: 447.0 g of butyl acrylate (BA), 300 ml of methyl ethyl ketone (MEK), 100 ml of methanol (MeOH), 2.51 g of 2,6-dibromodiethylheptanedionate (DBDEHD) as initiator, and 0.161 g of tris[2-(dimethylamino)ethyl]amine (Me₆-TREN) as ligand. The polymerization was carried out under nitrogen at an external temperature of 60° C. Once >95% BA conversion had been reached it was possible to carry out the polymerization of the second block via introduction of 558 g of methyl methacrylate (MMA) and 0.815 g of NaCl. 100 ml of DMSO were also added in order to reduce the viscosity of the reaction solution. Increasing the external temperature to 80° C. ensured full monomer conversion, determined by means of solids content and ¹H NMR spectroscopy. The product was obtained via precipitation in methanol and drying in a vacuum oven.

Analytical product composition (from ¹H NMR and GPC):

DPₙ(PMMA)=1.7*DPₙ(PBA)

Mₙ=92 500 g/mol

### Triblock Copolymer K2-4

A copper wire of length 12.5 cm was wound around the stirrer magnet of the reaction apparatus before the following were added in succession: 17.8 g of butyl acrylate (BA), 20 ml of DMSO, 0.10 g of 2,6-dibromodiethylheptanedionate (DBDEHD) as initiator, and 12.9 mg of tris[2-(dimethylamino)ethyl]amine (Me₆-TREN) as ligand. The polymerization was carried out under nitrogen at an external temperature of 60° C. Once >95% BA conversion had been reached it was possible to carry out the polymerization of the second block via introduction of 14.1 g of methyl methacrylate (MMA) and 32 mg of NaCl. Increasing the external temperature to 80° C. ensured full monomer conversion, determined by means of solids content and ¹H NMR spectroscopy. The product was obtained via precipitation in methanol and drying in a vacuum oven.

Analytical product composition (from ¹H-NMR and GPC)

DPₙ(PMMA)=1.3*DPₙ(PBA)

Mₙ=116 000 g/mol

The triblock copolymers K2-1 and K2-2 (see table 1) were likewise produced as in the above specification for K2-3 and, respectively, K2-4.

TABLE 1
Characterization and analytical data of the triblock copolymers
K2-1, K2-2, K2-3, and K2-4

| | Mₙ^{BC}(GPC) | | PBA:PMMA | PBA:PMMA |
|---|---|---|---|---|
| | [g/mol] | M_{w}/Mₙ | (th) | (NMR) |
| K2-1 | 89 200 | 1.5 | 1.0:1.0 | 1.0:1.04 |
| K2-2 | 111 300 | 1.4 | 1.0:1.0 | 1.00:1.1 |
| K2-3 | 92 500 | 1.6 | 1.0:1.5 | 1.0:1.7 |
| K2-4 | 116 000 | 1.4 | 1.0:1.0 | 1.0:1.3 |

TABLE 2
Mechanical data of the triblock copolymer K2-2

| | K2-2 |
|---|---|
| Vicat A₅₀ [° C.] | 55 |
| ak (23° C.) [kJ/mm²] | 20 |
| MVR (220/10) [ml/10 min] | 2.3 |
| Modulus of elasticity [MPa] | 389 |
| Yield stress [MPa] | 10 |
| Tensile strain at break [%] | 65 |

### Styrene-Ccrylonitrile (SAN) Copolymer

Three different SAN copolymers were used, obtainable commercially with trademark Luran®. Table 3 lists the analytical data of the SAN copolymers used (K1-1 and K1-2).

TABLE 3

| | AN [% by | | | |
|---|---|---|---|---|
| SAN copolymer | wt.] | Mₙ [g/mol] | M_{w}/Mₙ | VZ |
| K1-1 | 19 | 97 700 | 2.39 | 99 |
| K1-2 | 25 | 70 800 | 2.42 | 80 |

### Production of the Thermoplastic Molding Compositions of the Invention

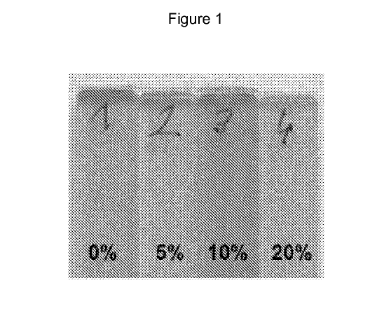

The thermoplastic molding compositions of the invention were produced by mixing the respective components (SAN copolymer+triblock copolymer) in an extruder (ZSK 30 twin-screw extruder from Werner & Pfleiderer) intimately at a temperature of 220° C., and producing appropriate moldings via injection molding at mold temperature 90° C. It was possible to mix the various triblock copolymers homogeneously into all three SAN polymer matrices. Proportions of up to 20% by weight of the respective triblock copolymer, based on the total quantity of components K1 and K2, give a transparent, clear composite material (table 4 and FIG. 1).

TABLE 4
Optical properties of the thermoplastic molding compositions of the
invention in comparison with SAN copolymers

| | | K1-1 + 20% | | K1-2 + 20% |
|---|---|---|---|---|
| | K1-1 | K2-2 | K1-2 | K2-2 |
| | comparison | inventive | comparison | inventive |
| Transmittance | 88.7 | 79.3 | 89.9 | 63.4 |
| [%] | | | | |
| Haze [%] | 2.38 | 4.44 | 1.25 | 16.5 |
| Clarity [%] | 99.1 | 98.9 | 99.3 | 98.7 |

FIG. 1 shows photographs of composite materials made of the SAN copolymer K1-1 and the triblock copolymer K2-1. The proportion of the triblock copolymer K2-1 is 0, 5, 10, and 20% by weight, based on the total quantity of components K1 and K2.

The results of mechanical property testing on the thermoplastic molding compositions of the invention are shown in tables 5 and 6 in comparison with those of the SAN copolymers used.

The proportion of the triblock copolymer K2-1 (table 5) and, respectively, K2-2 (table 6) is 20% by weight, based on the entire quantity of components K1 and K2.

TABLE 5
Modulus of elasticity and yield stress of the thermoplastic molding
compositions of the invention in comparison with SAN copolymers

| | Modulus of | |
|---|---|---|
| | elasticity | Yield stress |
| | (MPa) | (MPa) |
| K1-2 (comparison) | 3546 | 88 |
| K1-2 + 20% of K2-1 | 2998 | 56 |
| K1-1 (comparison) | 3228 | 78 |
| K1-1 + 20% of K2-1 | 2726 | 70 |

The results in table 5 show that although yield stress is reduced by addition of the triblock copolymer, it is not substantially impaired thereby. At the same time, there was only a slight reduction, to an acceptable extent, in modulus of elasticity.

TABLE 6
Modulus of elasticity and tensile strain at break of the thermoplastic
molding compositions of the invention in comparison with
SAN copolymers

| | Modulus of | Tensile strain |
|---|---|---|
| | elasticity | at break |
| | (MPa) | (%) |
| K1-2 | 3546 | 0 |
| K1-2 + 20% | 2998 | 15 |
| K1-1 | 3228 | 0 |
| K1-1 + 20% | 2726 | 12 |

The tensile strain at break of the SAN copolymers K1-2 and K1-1 is zero.

Table 6 shows that the thermoplastic molding compositions of the invention made of SAN copolymers K1-2 and, respectively K1-1 and of the triblock copolymer K2-2 gave very good tensile strain values of 15 and, respectively, 12% prior to break. At the same time, there was only a slight reduction, to an acceptable extent, in modulus of elasticity.

The results from the mechanical tests in Tables 5 and 6 show that addition of the triblock copolymer used in the invention to a SAN copolymer used in the invention can give a composite material with good transparency and high tensile strain at break, and also with acceptable modulus of elasticity.

1-10. (canceled)

11. A thermoplastic molding composition composed of the following components
K1: from 60 to 90% by weight of at least one copolymer K1 made of:
K11: from 70 to 85% by weight of at least one styrene or styrene derivative K11,
K12: from 30 to 15% by weight of at least one ethylenically unsaturated monomer K12 comprising a nitrile group,
K13: from 0 to 20% by weight of at least one other, copolymerizable monomer K13,
where the entirety of K11, K12, and K13 gives 100% by weight;
K2: from 40 to 10% by weight of at least one linear A-B-A triblock copolymer K2 made of:
A: from 50 to 70 mol % of hard polymer blocks A comprising at least one C₁- to C₄-alkyl methacrylate (A1); and
B: from 30 to 50 mol % of a soft polymer block B composed of at least one C1- to C₁₂-alkyl acrylate B1;
K3: from 0 to 10% by weight of auxiliaries and/or additives; and
K4: from 0 to 15% by weight of at least one copolymer K4 made of styrene and of another ethylenically unsaturated comonomer which comprises no nitrile group;
where the entirety of components K1 to K4 gives 100% by weight.

12. The thermoplastic molding composition of claim 11, characterized in that the quantity used of component K1 is from 70 to 90% by weight, and the quantity used of component K2 is from 30 to 10% by weight.

13. The thermoplastic molding composition of claim 11, characterized in that the copolymer K1 is composed of:
K11: from 70 to 85% by weight, in particular from 70 to 83% by weight, of at least one styrene or styrene derivative K11, and
K12: from 30 to 15% by weight, in particular from 30 to 17% by weight, of at least one ethylenically unsaturated monomer K12 comprising a nitrile group,
where the entirety of K11 and K12 is 100% by weight.

14. The thermoplastic molding composition of claim 11, characterized in that the copolymer K1 is a copolymer of styrene and acrylonitrile.

15. The thermoplastic molding composition of claim 11, characterized in that an A-B-A triblock copolymer K2 is used, made of:
A: polymer blocks A made of methyl methacrylate and/or ethyl methacrylate, and
B: a polymer block B made of n-butyl acrylate and/or ethylhexyl acrylate.

16. The thermoplastic molding composition of claim 11, characterized in that polymethyl methacrylate-block-polybutyl acrylate-block-polymethyl methacrylate is used as A-B-A triblock copolymer K2.

17. The thermoplastic molding composition of claim 11, characterized in that an SAN copolymer with molar mass from 50,000 to 120,000 g/mol is used as component K1, and the AN content of the SAN copolymer is preferably from 18 to 28% by weight.

18. The thermoplastic molding composition of claim 11, characterized in that the quantity of component K1 used is from 71 to 86% by weight and the quantity of component K2 used is from 29 to 14% by weight.

19. A molding or film produced from the thermoplastic molding composition of the invention of claim 11.

20. A method of use of films and moldings of claim 19 for external applications, or for the production of packaging material, or for the production of devices for medical technology or for medical diagnostics, or in the toy sector and household sector.
